(19) United States
(12) Patent Application Publication
(10) Pub. No.: US 2003/0112959 A1
(43) Pub. Date: Jun. 19, 2003

(54) Call reception system

(76) Inventor: Masato Mori, Saitama-city (JP)

Correspondence Address: RABIN & CHAMPAGNE, PC, 1101 14TH STREET, NW, SUITE 500, WASHINGTON, DC, 20005, US

(21) Appl. No.: 10/197,440

(22) Filed: Jul. 18, 2002

(30) Foreign Application Priority Data
Dec. 13, 2001 (JP) 2001-380132

(51) Int. Cl. H04M 3/00; H04M 5/00

(52) U.S. Cl. 379/265.01

(57) ABSTRACT

A call reception system includes a server equipped with a database to register inquiry examples and answer examples corresponding to the inquiry examples made previously, and a operator terminal equipped with a display device to display the inquiry examples and answer examples.

### BACKGROUND OF THE INVENTION

1. Field of the Invention

The present invention relates a call reception system.

2. Description of the Related Art

A call center which accepts telephone inquiries accepts and answers inquiries and consultations from customers about various services and products provided by a company. In this case, an operator of the call center copes with telephone inquiries, consultations, and so on from customers referring to the materials, which mentions about businesses of the company, services, products, and so on, corresponding to said inquiries and consultations. In many cases, an answer manual which includes questions asked frequently in past experience (i.e. FAQ), answer examples to assumed inquiries, and consultations made previously is given to said operator as a reference data. In this case, by only looking for a model answer apply with referring to the above answer manual, said operator can reply to most of usual inquiries and consultations without referring to other reference data. That makes an operator's working burden reduce and business efficiency in a call center improve.

In recent years, the computer system which can display the contents of said answer manual collection in the display device of the computer allocated to each operator is developed. In this case, by looking for an inquiry example and an answer example by operating the computer, said operator can find an appropriate answer example far more efficiently than by turning over pages of a booklet-shaped answer manual. Much reduction of an operator's working burden improves the work efficiency in the call center, and more proper answer improves the work quality in the call center.

However, as for the computer system in said call center, when an operator looks for the answer example corresponding to an inquiry or a consultation, he or she needs to input various conditions by operating an input unit such as a keyboard. In this case, the operator has to operate said input unit while answering the telephone inquiry or the consultation, thereby causing the operator's work burden heavier. Because it takes time before the answer example is displayed in the display device after various conditions are input, a reply to the customer becomes slow and the work efficiency in the call center goes down.

### SUMMARY OF THE INVENTION

This invention aims to provide a call reception system to reduce operators' working burden, make a reply to a customer fast, and improve the work efficiency and the work quality in a call center by setting inquiry examples and answer examples to be paid attention to, that is highly remarked ones, from inquiry examples and answer examples and by displaying them in the display device used by an operator.

A call reception system according to one aspect of this invention comprises a server equipped with a database to register inquiry examples and answer examples to said inquiry examples made in advance, and an operator terminal equipped with a display device to display said inquiry examples and answer examples, wherein said display device displays attention needed information.

This call reception system reduces operators' working burden and makes a reply to a customer fast, and improves the work efficiency and the work quality in a call center.

Said display device may always display said attention needed information.

Said display device may display said attention needed information upon an operators' operation.

For example, said attention needed information is an inquiry example and an answer example to said inquiry example to which an operator should pay attention.

Said display device may give attention level classification information to said attention needed information to display.

Said display device may display a screen to input the content of a received inquiry with said attention needed information.

Said display device may display the screen to display the details of said attention needed information.

The call reception system according to another aspect of this invention may comprises a server equipped with a data base to register inquiry examples and answer examples to said inquiry examples made in advance, and an operator terminal equipped with a display device to display said inquiry examples and answer examples. Said database may registers attention level classification information corresponding to said inquiry examples and answer examples.

Said attention level classification information is information, for example, to distribute whether information is attention needed information.

Said attention level classification information may be prepared when said inquiry examples and answer examples are registered.

Said attention level classification information may be set in accordance with a specific season or time.

Said attention level classification information may be canceled in setting when said season or time has passed.

Said database may register the priority order to display said inquiry examples and answer examples in said display device.

Said priority order may be decided based on the use actual results of said inquiry example and the answer example.

Said priority order may be set in accordance with a specific season or a time.

Said priority order may be cancelled when said season or time has passed.

### BRIEF DESCRIPTIONS OF THE DRAWINGS

FIG. 1 shows a schematic diagram of the configuration of a call reception system according to a first embodiment of the present invention.

FIGS. 2A and 2B show an example of a display screen of a display device of an operator terminal of the first embodiment.

FIG. 3 shows the operation of the call reception system of a first embodiment.

FIG. 4 shows the operation of the call reception system of a second embodiment.

FIG. 5 shows the operation of the call reception system of a third embodiment.

FIG. 6 shows the operation of the call reception system of a fourth embodiment.

FIG. 7 shows the operation of the call reception system of a fifth embodiment.

FIG. 8 shows the operation of the call reception system of a sixth embodiment.

FIG. 9 shows the operation of the call reception system of a seventh embodiment.

FIG. 10 shows the operation of the call reception system of a eighth embodiment.

FIG. 11 shows the operation of the call reception system of a ninth embodiment.

FIG. 12 shows the operation of the call reception system of a tenth embodiment.

### DETAILED DESCRIPTION OF THE INVENTION

The following describes the embodiments of this invention in detail with referring to the drawings.

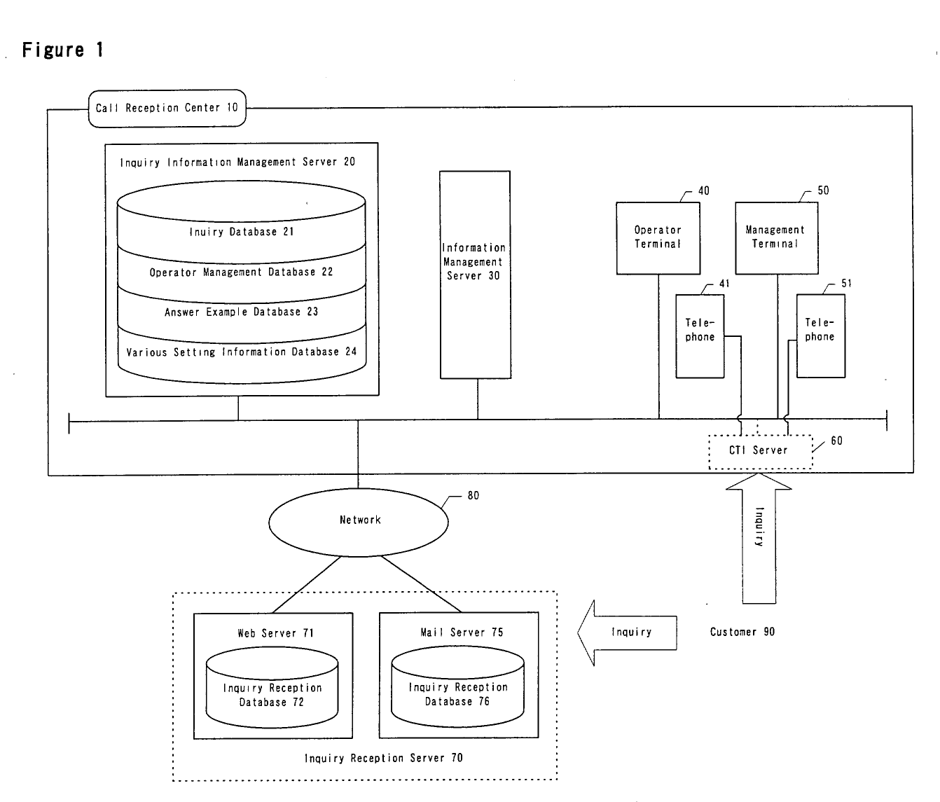

FIG. 1 shows a schematic diagram of the configuration of a call reception system according to the first embodiment of this invention.

In the figure, reference numeral 10 designates a call reception center, that works as a call center to accept a telephone inquiry from customer 90. Here, said call reception center 10 accepts various inquiries, consults, claims, or requests (referred to as “inquiry”) from customer 90 about business ranges, provided service, products, advertisements of a certain company or organization (e.g. bank, brokerage, insurance company, manufacturing or selling company of computer, software, motor car, electrical device and electronic device and soon, kind of shops such as department store and supermarket, accommodations such as hotels and inns, and passenger traffic company such as railways company and air carriers), which are replied by operators.

Call reception system 10 includes inquiry data base 21 which manages inquiry information, operator management data base 22, answer example data base 23 as a data base which said inquiry example and answer examples to the inquiry examples made in advance are registered in, inquiry information management server 20 equipped with setting information data bases 24, operator terminal 40 where various information are retrieved an operator inputs the contents of the inquiry, administrator terminal 50 which an administrator operates, and information management server 30 which stores and manages helpful information such as pamphlets, homepage information of the Internet, or manuals. Here, said inquiry information management server 20, information management server 30, operator terminal 40 and administrator terminal 50 are computers equipped with arithmetic units like CPU or MPU, memory device like magnetic disk or semiconductor memory, I/O device like keyboard or/and, mouse, display device like CRT or liquid crystal display (LCD), and communication interface, and can be connected to each other.

Telephone 41 for an operator to accept a telephone inquiry from customer 90 and to reply it is located coupled to operator terminal 40. It is desirable that telephone 51 is located coupled to administrator terminal 50 to allow an administrator accept and reply said inquiry in place of an operator.

It is possible that said telephones 41 and 51 are directly connected with the public telephone network (Ones via the exchange such as PBX are contained.), or connected via CTI server 60 which use CTI technology or via the Internet (so-called a Web phone). However, the methods are not limited above, any suitable devices which take place of the telephone machines 41 and 51 might be used.

It is possible to accept an inquiry from customer 90 if customer 90 writes to the homepage of the Web or by the electronic mail and so on. the inquiry from the customer 90 is received in inquiry reception server 70 which has Web server 71 and mail server 75. Web server 71 and mail server 75 respectively have data bases 72 and 76 which manage inquiry information. The inquiry from said customer 90 is transmitted through network 80 such as the intranet, LAN, WAN, and the Internet from inquiry reception server 70 to call reception center 10. It is possible that inquiry reception server 70 and inquiry information management server 20 become one.

Generally, many of inquiries which are coped with in a call center like call reception center 10 are concentrated on the contents of the specific kind.

In this embodiment, from the experiences in the past, inquiry examples and answer examples to said inquiry examples as questions which are asked frequently and the presumed inquiries are made in advance and registered in answer example database 23 in advance as answer example information in the form of a combination of said inquiry example and said answer example. Then, the answer example information which is used intensively is set as inquiry examples and answer examples to the inquiry examples which operators should pay attention to, that is, the attention needed information. Other answer example information is made general information. Then, said attention needed information is set to be always displayed in the display device of operator terminal 40 in call reception center 10.

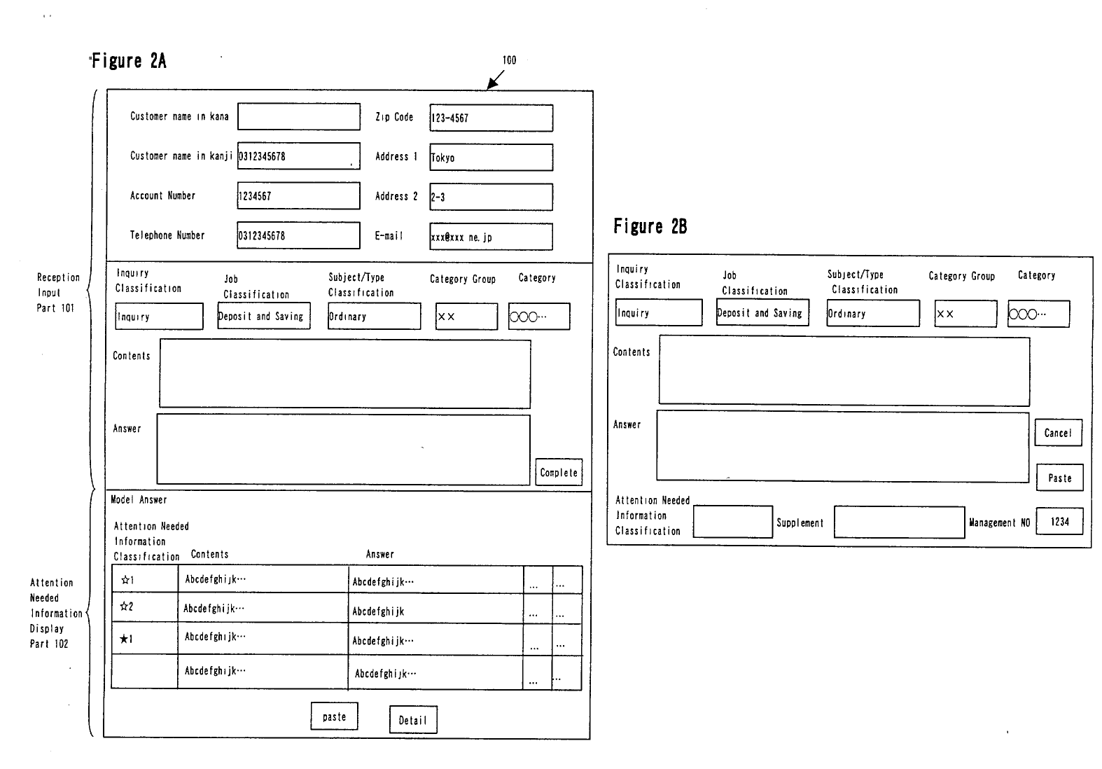

FIGS. 2A and 2B show an example of a display screen of an operator terminal in said first embodiment of this invention.

Here, the example of a display screen shown in FIG. 2 shows the example that call reception center 10 is a call center of a banking agency where call reception center 10 accepts a telephone inquiry from customer 90 about business matters, provided services, products, or advertisements which are to be replied by operators.

As shown in FIG. 2A, input screen 100 of operator terminal 40 (FIG. 1) at an inquiry reception has reception input part 101 as a screen to which customer information and contents of the accepted inquiry are input and attention needed information display part 102.

The information which is displayed in attention needed information display part 102 is the attention needed information which is most frequently inquired recently, which is chosen from the seasonal viewpoint such as a transfer, DM, or chosen from the viewpoint of a campaign for new goods and relates to a gossip like the item pointed out by the mass media such as a television

When an operator chooses attention needed information displayed on attention needed information display part 102, the screen is displayed to display the details of said attention needed information with a POP window form as shown in FIG. 2B.

The following describes the operation of said call reception system. Here, the case of the telephone inquiry is described.

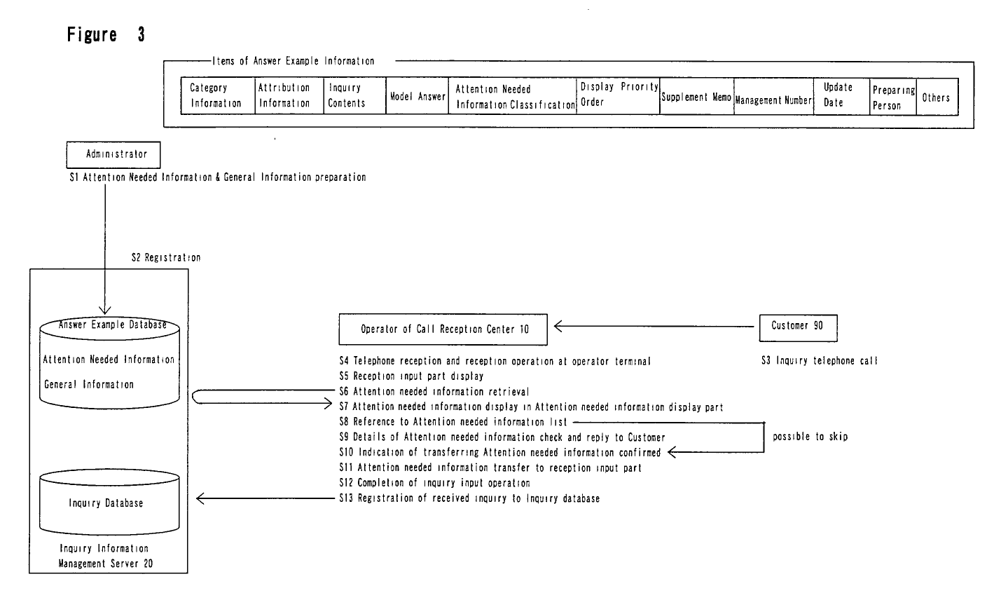

FIG. 3 shows the operation of the call reception system according to the first embodiment of this invention.

At first, the pre-work operation is described.

An administrator or supervisor (in the headquarters section or the controlling section) prepares presumed inquiries as frequently-asked questions, assumed questions, and answer examples to these inquiries from his experiences in the past, and then registers (adds or updates) them as answer examples in answer examples database 23 in advance. Then, the answer example information whose use is concentrated on is set as the attention needed information. Answer example information which isn't set as the attention needed information is made general information. The attention needed information might be made and set as a new one, or might be prepared from general information which has been already registered.

Items of said answer example information include the classification information which becomes the key to narrow the range of answer example information, the attribute information which the attribute (category) of the answer example information is shown in, inquiry contents, a model answer, the attention needed information classification as attention rank classification information which the importance of attention or the use frequency is shown in, the display priority order to attention needed information display part 102 of input screen 100 (FIG. 2A), supplement memo, control number, updating date and preparation person. For example, when call reception center 10 is a call center of a banking agency, said classification information contains the inquiry classification as a big classification, the service as the middle classification, and subject/type classification as the small classification. Said inquiry classification contains items such as inquiry, consultation and complaint, and service classification may be a service related to businesses of the banking agency such as deposit and saving, funds transfer, a national bond, and attribute information includes system, procedure and so on.

When an administrator registers said answer example information in answer example data base 23, the administrator can manually input the attention needed information one by one from administrator terminal 50, and rewrite or add to said answer example data base 23 by a file (for example, a medium such as a CD, a DVD or a MO, or a file transfer) which contains many attention needed information prepared in advance.

The following describes the operation when the operator of the call reception center has a telephone call.

At first, customer 90 calls call reception center 10. In call reception center 10, an operator receives the call with telephone 41 and begins an operation of reception of the telephone inquiry. At this time, the display device of operator terminal 40 displays input screen 100 including reception input part 101.

At the same time when displaying reception input part 101 in the display device, operator terminal 40 accesses inquiry information management server 20 automatically to retrieve attention needed information registered in answer example database 23, and then obtains retrieved attention needed information. Then operator terminal 40 displays the acquired attention needed information automatically in attention needed information display part 102, which is laid out by the reception input part 101 in a row, in accordance with the display priority order (turn). The display priority order indicates the order in which a plurality of answer example information is displayed in the display device of operator terminal 40. Said display priority order is set and given to each answer example information. There may be provided a button by which the operator can operate to retrieve and display attention needed information.

While the operator is answering customer 90, the operator checks whether attention needed information whose contents is corresponding to the inquiry from customer 90 is displayed in attention needed information display part 102. When the contents of the attention needed information correspond to the inquiry from customer 90 are displayed, the operator selects a suitable line of the attention needed information and presses the detail button. By pressing the button, the details of the selected attention needed information is displayed in the form of a POP window shown in FIG. 2B, and then the operator confirms contents of the model answers displayed and replies to the inquiry of said customer 90 according to them.

Then, when the operator presses a paste button, said selected attention needed information is automatically transferred to each input column of reception input part 101. Items which are input automatically are classification information such as inquiry classification, service classification, subject and type, category information such as category group and category classification, contents of the inquiry, and a model answer. After the operator confirms the information automatically input to reception input part 101, he presses a complete button. When the operator pushes the complete button, the contents of the inquiry input are registered in inquiry data base 21 of inquiry information management server 20.

When the attention needed information with the contents corresponding to the inquiry is not displayed, the operator copes with the inquiry of said customer 90 with operating the input unit of operator terminal 40 by entering a keyword to retrieve other attention needed information (and, general information), or by the operator's own skill in the same way as before without referring to attention needed information.

Disconnection after response to customer 90 will be done properly, so the description about that is omitted.

The steps shown in FIG. 3 are described.

Step S1: An administrator prepares answer example information, that is, attention needed information and general information.

Step S2: The prepared attention needed information and general information is registered in answer example data base 23 of inquiry information management server 20.

Step S3: Customer 90 makes a telephone inquiry to call reception center 10.

Step S4: An operator of call reception center 10 receives the telephone call, and performs the reception operation for the telephone inquiry at operator terminal 40.

Step S5: Operator terminal 40 displays reception input part 101.

Step S6: The attention needed information is retrieved.

Step S7: The attention needed information display part 102 displays the attention needed information.

Step S8: The operator refers to the list of the attention needed information, and checks whether the attention needed information corresponding to the inquiry exists.

Step S9: The operator confirms the details of the attention needed information, and answers customer 90.

Step S10: The operator presses the paste button to transfer the confirmed attention needed information up to reception input part 101.

Step S11: The attention needed information is transferred to reception input part 101.

Step S12: Operation for inquiry acceptance and response is completed.

Step S13: The contents of the accepted inquiry are registered in inquiry data base 21.

Thus in this embodiment, in response to a telephone inquiry, the attention needed information which is supposed to be used frequently by operators is always displayed automatically on the display device in operator terminal 40. Therefore, without the operation of retrieving answer example information, an operator can refer to a model answer and immediately answer customer 90. That makes operators' workload lighten and work efficiency in call reception center 10 improve, thereby resulting in the improvement of the work quality of call reception center 10 and customer services.

The following is the description of the second embodiment of this invention. As the configuration of the call reception system in this embodiment is the same as that of the first embodiment, FIGS. 1 and 2 are also used here.

In the first embodiment, the attention needed information is prepared and registered by an administrator in advance, and displayed automatically according to the display priority order given to each attention needed information. Therefore, if the administrator does not change the setting of the display priory order of the attention needed information, the initial reception screen displays the same information as ever. When the frequency of use of each answer example information varies, it is considered that answer example information which is used more frequently than said attention needed information is not displayed as attention needed information. It is considered that the frequency of use of answer example information depends on contents of answer example information. For example, if answer example information is about address changes related to a workplace relocation, it is considered to be used frequently in April and October. If answer example information is about matters related to changes on a national level, such as payoff systems, defined contribution pension plans, or separate taxation systems, it is used frequently just before and after the system change. But the first embodiment cannot manage these cases sufficiently.

In this embodiment, to decide the display priority order according to a specific season or time, the number of use (the use condition) of prepared answer example information, that is, attention needed information and general information, is counted and managed as points to set the display order. Then the display priority order is set automatically by those points. Two kinds of information on 2-period average number of use and this, period number of use are added to items of answer example information.

The way that the display priority order is decided is followings; the number of use of the answer example information is counted in the specific period, for example, monthly, weekly or daily. Every use of answer example information (for example, pasting operation) is counted on the item of this period number of use. After the specific period, which is set up in advance in setting information data base 24 of inquiry information management server 20 (FIG. 1), has expired, the sum of 2-period average number of use and this period number of use is calculated, and then the average value of the 2-period average number of use and this period number of use is calculated (dividing the sum by the two periods). The 2-period average number of use is rewritten by the result of the calculation.

Then the display priority order is assigned to the information according to the ascending sequence of the 2-period average number of use rewritten. The answer example information which is ranked within the designated higher rank range of the order is made to semi-attention needed information. In the next period, the display order is fixed and used to display the attention needed information. Then the number of use will be counted again in the next period and the display order will be changed in the second next period. If a specific period is set in yearly units, it is impossible to immediately reflect a sudden change of the frequency of use by a season or a time. It is advisable that a specific period is set in a time unit of less than a year's.

It is possible that the attention needed information which is set for changeless information (always displayed at top priority as attention needed information in despite of its number of use) and the semi-attention needed information which is selected temporarily from general information in this embodiment (changeable information at any time on the basis of a frequency of use) may be displayed together. In the following description of the embodiments, it is defined that the information which always exits and has no change is called as attention needed information, while other information is called as general information.

The operation of said call reception system is described. As the operation of the call reception system of this embodiment is almost the same as that of the first embodiment, only different operation from the first embodiment will be described.

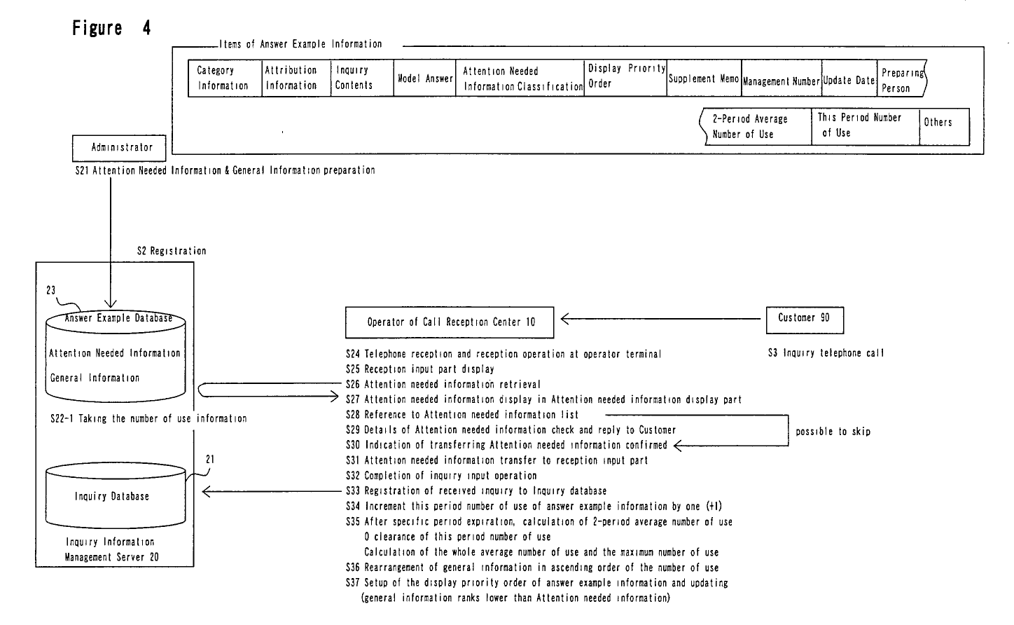

FIG. 4 shows the operation of the call reception system according to the second embodiment of this invention.

At first the pre-work operation is described. An administrator prepares attention needed information and general information, and registers it in answer example database 23. Items prepared by the administrator are almost same as those of the first embodiment except that items recording 2-period average number of use and this period number of use is added.

Thus, when answer example information which has been already registered is used and updated, the newly registered (updated) answer example information takes the number of use information counted in answer example database 23 of inquiry information management server 20.

The following describes the operation when the operator of the call reception center has a telephone call. Since the operation until the contents of the received telephone inquiry are registered in inquiry database 21 is the same as that of the first embodiment, the operation after that will be described.

The answer example database 23 records the use of paste button of the answer example information or the contents of the inquiry to inquiry database 21, and increases this period number of use of the answer example information by one.

Inquiry information management server 20 obtains a specific period from setting information database 24 to count the frequency of use of answer example information. When the specific period expires, the server calculates the sum of 2-period average number of use and this period number of use recorded in each answer example information which is registered in answer example database 23, calculates the average (divided by two), rewrites the column of the 2-period average number of use, and initializes this period number of use into zero. The server also calculates the whole average number of use and the maximum number of use.

The server abstracts only general information and compares such general information in size of 2-period average number of use, and rearranges the information in ascending sequence. Though the way of rearrangement is described here, it is possible only to update the contents of the display priority order of each answer example information without rearrangement of the information.

Then, the display priority order whose value is lower than that of the attention needed information at top priority is assigned to the rearranged order, and the item of the display priority order in the answer example information is rewritten and updated with the order. The attention needed information set at top priority at the preparation of answer example information by the administrator does not update the display priority order at the attention needed information display part 102 (FIG. 2).

During the next period, the attention needed information, which is supposed to be used most frequently, will be displayed according to the updated display priority order at attention needed information display part 102. The information set as the attention needed information at top display priority by the administrator is display at top priority.

The steps shown in FIG. 4 are described.

Step S21: An administrator prepares answer example information, that is, attention needed information and general information.

Step S22: The prepared attention needed information and general information is registered in answer example data base 23 of inquiry information management server 20.

Step S22-1: Answer example database 23 takes the number of use information.

Step S23: Customer 90 makes a telephone inquiry to call reception center 10.

Step S24: An operator of call reception center 10 receives the telephone call, and performs the reception operation of the telephone inquiry at operator terminal 40.

Step S25: Operator terminal 40 displays reception input part 101.

Step S26: The attention needed information is retrieved.

Step S27: Attention needed information display part 102 displays the attention needed information.

Step S28: Referring to the list of the attention needed information, the operator checks whether the attention needed information corresponding to the inquiry exists.

Step S29: The operator confirms the details of the attention needed information, and answers customer 90.

Step S30: Pasting up the confirmed attention needed information is indicated.

Step S31: The attention needed information is transferred to reception input part 101.

Step S32: Operation for inquiry acceptance and response is completed.

Step S33: The contents of the accepted inquiry are registered in inquiry database 21.

Step S34: This period number of use of the answer example information increments by one.

Step S35: After a specific period expires, the 2-period average number of use is updated by a new calculation and making this period number of use 0, both the whole average number of use and the maximum number of use are calculated.

Step S36: General information is rearranged in ascending order of the number of use.

Step S37: The display priority order is assigned to the rearranged general information with the value which is lower than that of the attention needed information at the top priority. The resultant display priority order is set in item of the answer example information.

In this embodiment, because the display priority order is set according to the number of use checked in a short period, the answer example information can be alternated dynamically with one which is highly needed to refer by operators in a specific season or period. That improves the work efficiency of an operator and the convenience of using operator terminal 40, and provides a call reception system easily operable by an operator. Retrieval operation of answer examples is also simplified.

Furthermore, because the setting of the display priority does not depend on the attention needed information set at the preparation of them but the automatic count, an administrator will be free from management of the attention needed information.

The following is the description of the third embodiment of this invention. As the configuration of the call reception system of this embodiment is the same as the first embodiment, FIGS. 1 and 2 are also used here.

In the second embodiment, the display order is determined by the ascending order as the result of the calculation of the average value from the sum of 2-period average number of use and this period number of use. However, because 2-period average number of use for newly added answer example information is 0, the display priority order ranks lower. Therefore improper display priority is held for a while. For example, when the number of use of newly added answer example information in this period, that is, this period number of use is 100, 2-period average number of use in the next period becomes (0+100)/2=50, because the number of use in the last period is 0. Even if the number of use during the second next period is also 100, 2-period average number of use during the second next period becomes (50+100)/2=75.

In this embodiment, therefore, the server determines whether 2-period average number of use is grater than 0 or not. When the 2-period average number of use is more than 0, the average value of the 2-period average number of use and this period number of use becomes a new 2-period average number of use. When the 2-period average number of use is 0, this period number of use itself becomes the 2-period average number of use.

The operation of said call reception system is described. As the operation of the call reception system of this embodiment is almost the same as that of the first and the second embodiments, only different operations from the first and the second embodiments is described.

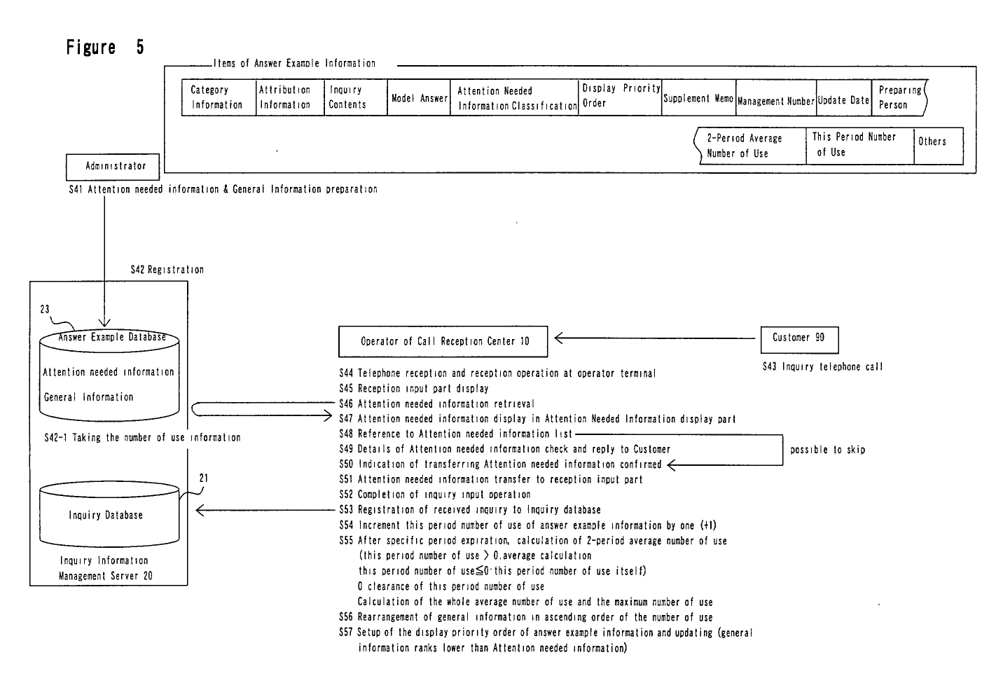

FIG. 5 shows the operations of a call reception system according to the third embodiment of this invention.

The description of pre-work operations, which is the same as that of the second embodiment, is not repeated here.

The following describes the operation when the operator of the call reception center has a telephone call. Because the operation until this period number of use of the answer example information which is used in response to the telephone inquiry increments by one is the same as that of the second embodiment, the operation after that will be described.

Inquiry information management server 20 obtains a specific period from setting information database 24 to count the frequency of use of answer example information. When the specific period expires, the server confirms 2-period average number of use and this period number of use recorded in each answer example information which is registered in answer example database 23, and determines whether 2-period average number of use is more than 0. When the number is more than 0, the server sums up 2-period average number of use and this period number of use in each answer example information, calculates the average value (divided by 2), and updates the column of 2-period average number of use with the average value. When the number is 0, the server changes this period number of use directly to the 2-period average number of use and initializes this period number of use to zero. Furthermore, the whole average number of use and the maximum number of use are calculated in parallel. Because the operation after that is the same as that of the second embodiment, the description is omitted.

The steps shown in FIG. 5 are described.

Step S41: An administrator prepares answer example information, that is, attention needed information and general information.

Step S42: The prepared attention needed information and general information is registered in answer example data base 23 of inquiry information management server 23.

Step S42-1: Answer example database 23 incorporates the number of use information into the answer example information.

Step S43: Customer 90 makes a telephone inquiry to call reception center 10.

Step S44: An operator of call reception center 10 receives the telephone call, and performs the reception operation of the telephone inquiry at operator terminal 40.

Step S45: Operator terminal 40 displays reception input part 101.

Step S46: The attention needed information is retrieved.

Step S47: Attention needed information display part 102 displays the attention needed information.

Step S48: Referring to the list of the attention needed information, the operator checks whether the attention needed information corresponding to the inquiry exists.

Step S49: The operator confirms the details of the attention needed information, and answers customer 90.

Step S50: The operator presses the transfer button to transfer the confirmed attention needed information.

Step S51: The attention needed information is transferred to reception input part 101.

Step S52: Operation for inquiry acceptance and response is completed.

Step S53: Contents of the accepted inquiry are registered in inquiry database 21.

Step S54: This period number of use of the answer example information increments by one.

Step S55: When the specific period expires, the server checks 2-period average number of use and this period number of use recorded in each answer example information, and determines whether the 2-period average number of use is more than 0. When the number is more than 0, the server sums up 2-period average number of use and this period number of use of each answer example information, calculates the average value, and updates the column of 2-period average number of use. When the number is 0, the server uses this period number of use for the 2-period average number of use to update. Then the server initializes this period number of use to zero and calculates the whole average number of use and the maximum number of use.

Step S56: General information is rearranged in ascending order of the number of use.

Step S57: The display priority order is assigned to the rearranged general information with the value which is lower than that of the attention needed information at the top priority. The resultant display priority order is set in item of the answer example information.

In this embodiment, how to decide the display priority order of answer example information depends on the substitution of the average value calculated from the 2-period average number of use and this period number of use for the 2-period average number of use when the 2-period average number of use is more than 0, or the direct substitution of this period number of use for the 2-period average number of use when the 2-period average number of use is 0, after determining whether the 2-period average number of use is grater than zero or not. This reflects an actual number of use on answer example information including the information which is newly made. Therefore, the display priority order of the general information can be set precisely, thereby decreasing the workload of an operator with reference to answer example information.

The following is the description of the fourth embodiment of this invention. As the configuration of the call reception system in this embodiment is the same as that of the first embodiment, FIGS. 1 and 2 are also used here.

In the second embodiment, the display order is determined by the ascending order in accordance with the result of calculating the average value from the sum of 2-period average number of use and this period number of use. However, because 2-period average number of use is 0 for newly added answer example information, the display priority order ranked lower. That provides improper display priority in some occasions.

This embodiment solves this problem in a way different from the third embodiment. This embodiment sets manually 2-period average number of use of newly added answer example information with an assumed number of use. When the 2-period average number of use has not been set, the display priority order is adjusted automatically by allocating the average value of the number of use of the whole answer example information which is registered, or could be treated as in the third embodiment.

It is considered that when changes on a national level, announcements of new products or the like will arouse rapid increase of inquiries about that. In this embodiment, by setting 2-period average number of use of answer example information with a higher value, the information is allowed to be displayed at higher priority order, thereby improving efficiency in choosing answer example information. The means to help the decision of the number of times to be set includes a function of displaying the calculation result of the average value of 2-period average number of use, the maximum value of it and so on as in said second embodiment. This allows to refer to and manually set 2-period average number of use using the contents of the display. Though the changes of the display priority order are reflected two periods later in the third embodiment, it is possible to reflect the changes immediately in this embodiment.

The operation of said call reception system is described. As the operation of the call reception system of this embodiment is almost the same as that of the first and the second embodiments, only different operations from the first and the second embodiments is described.

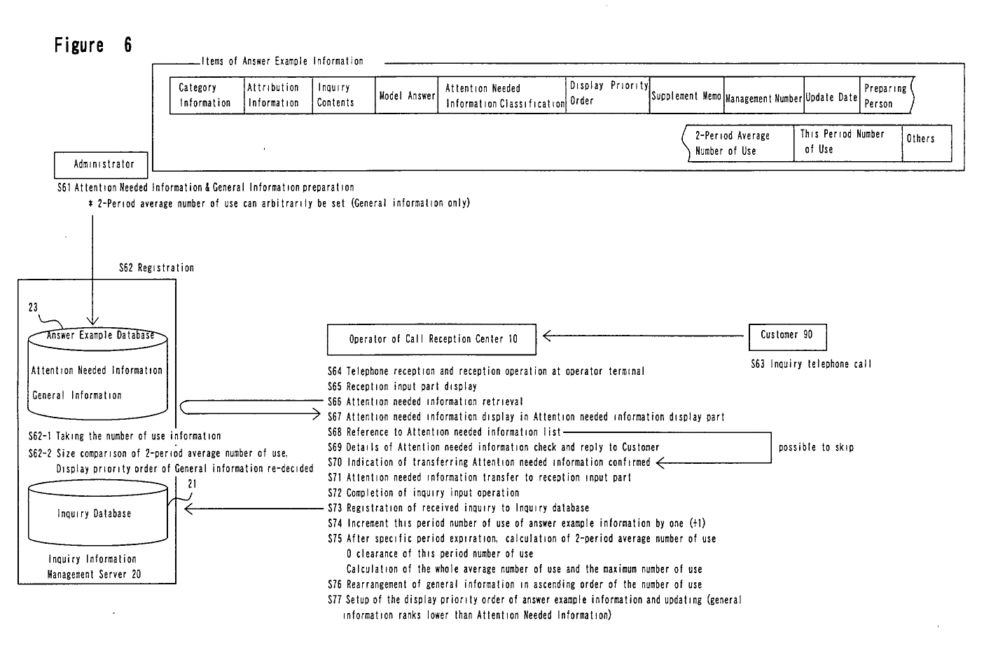

FIG. 6 shows the operation of the call reception system according to the fourth embodiment of this invention.

At first the pre-work operation is described.

An administrator prepares attention needed information and general information. A 2-period average number of use of the general information is input manually if necessary. As the items of answer example information to be prepared, the items to record 2-period average number of use and this period number of use are added as in said second embodiment. Furthermore 2-period average number of use can be set manually.

The prepared answer example information is previously registered (added or updated) in answer example database 23 of inquiry information management server 20 in the call reception system. In answer example database 23, when answer example information, which has been registered, is updated, the newly registered (updated) answer example information takes the number of use information counted in answer example database 23.

In accordance with a result of a size comparison of each 2-period average numbers of use of the general information, the information is rearranged in the ascending order (rearrangement can be omitted.), and is re-set in the display priority order.

The description of the operation when the operator of the call reception center has a telephone call, which is the same as that of the second embodiment, is not repeated here

The steps shown in FIG. 5 are described.

Step S61: An administrator prepares answer example information, that is, attention needed information and general information. 2-period average number of use of the general information can be set optionally.

Step S62: The prepared attention needed information and general information is registered in answer example data base 23 of inquiry information management server 23.

Step S62-1: Answer example database 23 incorporates the number of use information into the answer example information.

Step S62-2: 2-period average numbers of use are compared with each other in size and the general information is rearranged in the ascending order by the result of the comparison, and then the display priority order of the general information is set again in accordance with the rearranged general information.

Step S63: Customer 90 makes a telephone inquiry to call reception center 10.

Step S64: The operator of call reception center 10 receives the telephone call, and performs the reception operation of the telephone inquiry at operator terminal 40.

Step S65: Operator terminal 40 displays reception input part 101.

Step S66: The attention needed information is retrieved.

Step S67: Attention needed information display part 102 displays the attention needed information.

Step S68: Referring to the list of the attention needed information, the operator checks whether the attention needed information-corresponding to the inquiry exists.

Step S69: The operator confirms the details of the attention needed information, and answers customer 90.

Step S70: The operator presses the button to transfer the confirmed attention needed information to reception input part 101.

Step S71: The attention needed information is transferred to reception input part 101.

Step S72: Operation for inquiry acceptance and response is completed.

Step S73: Contents of the accepted inquiry are registered in inquiry database 21.

Step S74: This period number of use of the answer example information increments by one.

Step S75: After a specific period expires, the 2-period average number of use is updated by a new calculation and making this period number of use 0, both the whole average number of use and the maximum number of use are calculated.

Step S76: The general information is rearranged in ascending order of the number of use.

Step S77: The display priority order is assigned to the rearranged general information with the value which is lower than that of the attention needed information at the top priority. The resultant display priority order is set in item of the answer example information.

In this embodiment, because the 2-period average number of use of the answer example information which is newly made can be set up manually, the display priority order in accordance with an intention of the administrator who has prepared answer example information can be set at his or her choice. That enables to provide more convenient environment to an operator who answers customer 90 by referring to the attention needed information displayed on the display device of operator terminal 40.

In the third embodiment, as newly prepared information is set to 0 in the 2-period average number of use, it is ranked lower in the display priority order when registered in answer example database 23, and some specific periods are necessary to reflect proper display priority order. But it is possible to reflect immediately the proper display priority order in this embodiment.

The following is the description of the fifth embodiment of this invention. As the configuration of the call reception system in this embodiment is the same as that of the first embodiment, FIGS. 1 and 2 are also used for this embodiment.

There may be attention needed information which is intended to be displayed at priority in a specific period or season. In the second to fourth embodiments, because the display priority order is decided by the number of use related to the average value calculated from 2-period average number of use and this period number, it is impossible to display attention needed information which meets a specific period or season timely. In other words, in the second to fourth embodiments, the display priority order reflecting the evaluation based on the past record causes a delay by one period in reflection. In this embodiment, the number of use is added in a specific season or time to decide the display priority order corresponding to the specific season or time.

As items of each answer example information, an additional number of use (an addition point) and an additional applicable time applied to the additional number of use is added (for example, from dd/mm to dd/mm as a setting of a specific period, the first period of April, the first week of every month or April and October as an assignment of a regular period). When calculating the number of use, whether the applicable time is checked, an addition operation of the number of use is performed when it is the additional applicable time.

The operation of said call reception system is described. As the operation of the call reception system of this embodiment is almost the same as that of the first and the fourth embodiments, only different operations from the first and the fourth embodiments is described.

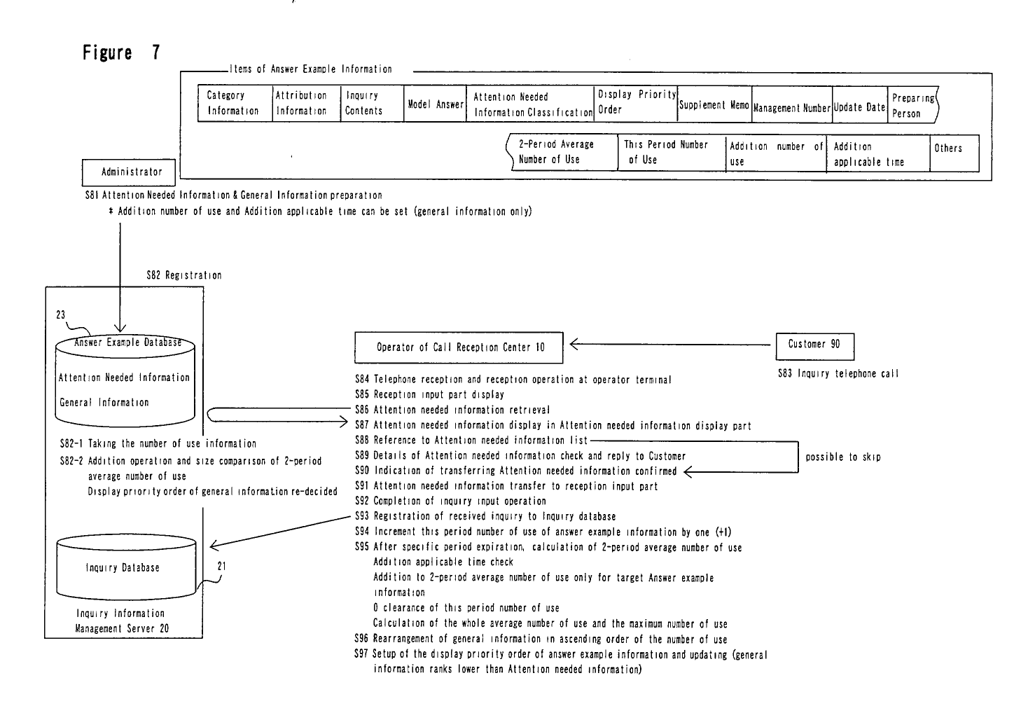

FIG. 7 shows the operation of the call reception system according to the fifth embodiment of this invention.

At first, the pre-work operation is described.

An administrator prepares attention needed information and general information. 2-period average number of use of the general information is input manually if necessary. The information on the additional number of use (addition point), the additional applicable time (for example, from dd/mm to dd/mm, in early April, the 1st week in every month or April and October) of the additional number of use is also input manually if necessary.

Then, the items of answer example information to prepare include the items of the additional number of use and the additional applicable time are added to the items of the fourth embodiment. The items of the additional number of use and the additional applicable time can be set manually.

The prepared answer example information is previously registered (added or updated) in answer example database 23 of inquiry information management server 20 in the call reception system. When the answer example information, which has been registered, is updated, the newly registered (updated) answer example information takes the information on the number of use counted in answer example database 23.

After performing the addition operation of 2-period average number of use, the general information is sorted in the ascending order by a size of 2-period average numbers of use if necessary, and the display priority order of the general information is set again. It should be noted that above sorting can be omitted.

The following describes the operation when the operator of the call reception center has a telephone call. Because the operation until this period number of use of the answer example information which is used in response to the telephone inquiry increments by one is the same as that of the fourth embodiment, the operation after that will be described.

Inquiry information management server 20 obtains a specific period from setting information database 24 to count frequency of use of answer example information. When the specific period expires, the server sums up 2-period average number of use and this period number of use recorded in each answer example information which is registered in answer example database 23, and then calculates the average value of them (division by 2).

Then the addition applicable information recorded on each answer example information is obtained. When it is time to apply, the additional number of use recorded on each answer example information is added to the average value calculated previously, and then the server rewrites the 2-period average number of use by the result and initializes this period number of use into 0. Here, as the calculation of 2-period average number of use is calculated by adding the number of use to the average value calculated previously when it is the additional applicable time. It is possible, however, that the additional applicable time is obtained first to decide whether it is applicable time and the average value including the additional number of use is calculated when it is applicable time [(2-period average number of use+this period number of use+the additional number of use)/2]. How to calculate the average value is not limited the above manners. Furthermore, the whole average number of use and the maximum number of use are calculated in parallel. Because the operation after that is the same as that of the second embodiment, the description is omitted.

The steps shown in FIG. 6 are described.

Step S81: An administrator prepares answer example information, that is, attention needed information and general information. 2-period average number of use of general information can be set optionally.

Step S82: Each 2-period average number of use is performed the addition operation and compared in size and the general information is rearranged in the ascending order by the result, and then the display priority order of the general information is set again in accordance with the rearranged general information.

Step S82-1: Answer example database 23 incorporates the number of use information into the answer example information.

Step S82-2: The addition operation is performed on the 2-period average number of use of the general information and resulting value are compared in sizes with each other. The general information is rearranged in the ascending order of the 2-period average number of use, and the display priority order of the general information is re-decided.

Step S83: Customer 90 makes a telephone inquiry to call reception center 10.

Step S84: An operator of call reception center 10 receives the telephone call, and performs the reception operation of the telephone inquiry at operator terminal 40.

Step S85: Operator terminal 40 displays reception input part 101.

Step S86: Attention needed information is retrieved.

Step S88: Referring to the list of the attention needed information, the operator checks whether the attention needed information corresponding to the inquiry exists.

Step S89: The operator confirms the details of the attention needed information, and answers customer 90.

Step S90: The operator presses the button to transfer the confirmed attention needed information.

Step S91: The attention needed information is transferred to reception input part 101.

Step S92: Operation for inquiry acceptance and response is completed.

Step S93: The contents of the accepted inquiry are registered in inquiry database 21.

Step S94: This period number of use of the answer example information increments by one.

Step S95: After a specific period expires, a new 2-period average number of use is calculated to update the current 2-period average number of use and it is checked whether the current time is applicable time. When it is the applicable time, the addition point is added again to the 2-period average number of use, and this period number of use is initialized to 0. The server also calculates the whole average number of use and the maximum number of use.

Step S96: The general information is rearranged in ascending order of the number of use.

Step S97: The display priority order is assigned to the rearranged general information with the value which is lower than that of the attention needed information at the top priority. The resultant display priority order is set in item of the answer example information.

In this embodiment, because it is possible to automatically add the number of use when the answer example information seems to be used frequently, and to decide the display priority order favorably, the answer example information can be displayed properly in each period in which the information is expected to be used frequently. This improves the hit rate of the attention needed information and provides more convenient environment to an operator who answers the inquiry from customer 90. This also simplifies the retrieval operation of answer example information.

The following is the description of the sixth embodiment of this invention. As the call reception system of this embodiment has the same configuration as that of the first embodiment, FIGS. 1 and 2 are also used here.

In the above-described fifth embodiment, though every answer example information holds the information of the additional number of use respectively, each answer example information needs to be set respectively. This causes difficulty of the change work when changes arise. In this embodiment, therefore, the additional number of use is managed in additional number of use file 25 which will be described later separately from each answer example information, and is set as common information. When an additional applicable time in each answer example information agrees with this period, the additional number of use which is managed as common information is added.

By preparing ranks (referred to as ‘addition rank’ hereinafter) in the additional number of use and giving them to each answer example information, it is possible to flexibly apply the additional number of use. For example, when there are three pieces of answer example information at priority for display, and their addition ranks are respectively given as 1, 2 and 3, the first answer example information 1 is added +50 to the number of use, the second one is added +30 to the number of use, and the third one is added +10 to the number of use, and then the display priority order is controlled by the size comparison of each numbers of use.

In this embodiment, the additional number of use, which is held in each answer example in the fifth embodiment, is substituted by the addition rank, and additional number of use file 25 is newly prepared. Additional number of use file 25 stores addition rank information and the additional number of use information in pairs.

The operation of said call reception system is described. As the operation of the call reception system of this embodiment is almost the same as that of the first and the fifth embodiments, only different operations from the first and the fifth embodiments is described.

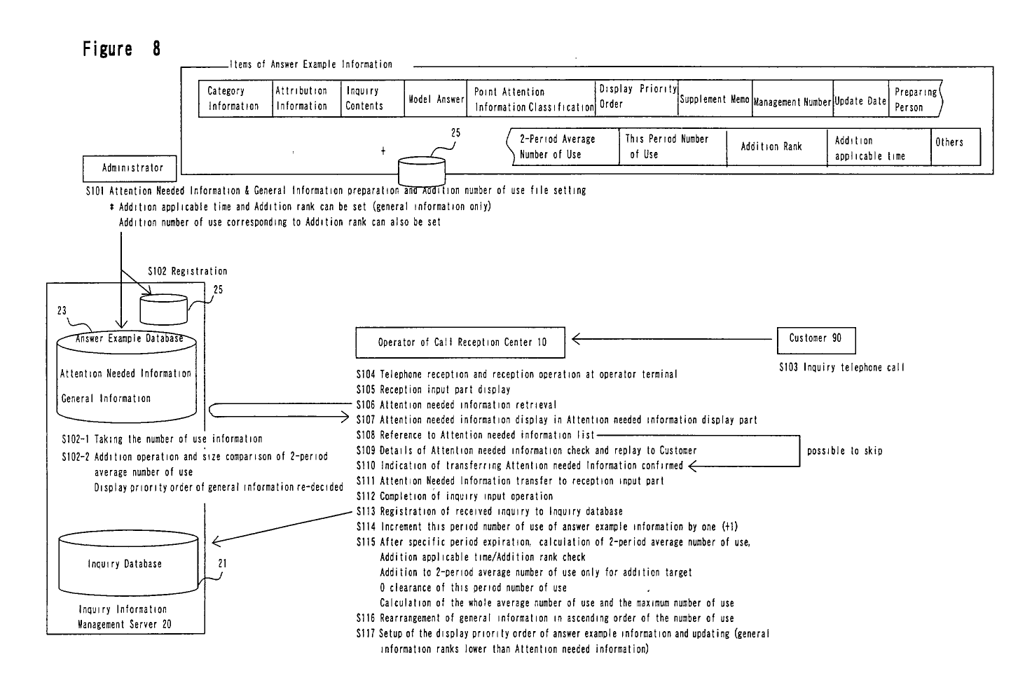

FIG. 8 shows the operation of the call reception system in the sixth embodiment of this invention.

At first, the pre-work operation is described.

An administrator prepares attention needed information and general information. As for the general information, 2-period average number of use is input manually if necessary. Information on the addition rank (which corresponds to additional number of use file 25 managed separately) and the additional applicable time (for example, in early April, the 1st week in every month, and so on) of the additional number of use is also input manually if necessary. The items of answer example information to prepare are the same as that of said fourth embodiment except that the additional number of use (additional point) is substituted by the addition rank. It is possible that the items on the addition rank and the additional applicable time can be set manually.

Answer example database 23 of inquiry information management server 20 (FIG. 1) in the call reception system previously registers (adds or updates) prepared answer example information. Additional number of use file 25 is also updated. When the answer example information which has been registered is updated, the newly registered (updated) answer example information takes the number of use information counted in answer example database 23.

After performing the addition operation to 2-period average number of use if necessary, each general information is compared with sizes of the 2-period average number of use of each other and rearranged in the ascending order of the 2-period average number of use, and the display priority order of the general information is set again. Above sorting can be omitted.

The following describes the operation when the operator of the call reception center has a telephone call. Since the operation until answer example information which is used in response to the telephone inquiry increments by one in this period number of use is the same as that of the second embodiment, the operation after that will be described.

Inquiry information management server 20 obtains a specific period from setting information database 24 to count frequency of use of answer example information. When the specific period expires, the server sums up 2-period average number of use and this period number of use recorded on each answer example information which is registered in answer example database 23, and calculates the average value of them (division by 2) to update the 2-period average number of use.

The additional applicable time recorded on each answer example information is obtained to determine whether it is applicable time. When it is the applicable time, the server recognizes the addition rank recorded on each answer example information, refers additional number of use file 25 managed as another file, and adds the additional number of use applying to the recognized addition rank to the average value calculated before. Then, the server updates the column of 2-period average number of use by the result and makes this period number of use 0. How to calculate 2-period average number of use is not limited to this way as well as in said fifth embodiment. The whole average number of use and the maximum number of use are calculated in parallel. Because the following operation is the same as that of the fifth embodiment, the description about that is omitted.

There are two ways of assigning of the addition rank; to simply assign the rank to each addition value, or to assign codes corresponding to the classification rank and addition rank in each type of the answer example information after obtaining the type. But, any other suitable way may be explained.

The steps shown in FIG. 8 are described.

Step S101: An administrator prepares answer example information, that is, attention needed information and general information. 2-period average number of use of the general information can be set optionally. The additional number of use corresponding to the addition rank can be also set.

Step S102: The prepared attention needed information and the general information is registered in answer example data base 23 of inquiry information management server 20. At the same time additional number of use file 25 is updated.

Step S102-1: Answer example database 23 incorporates the number of use information into the answer example information.

Step S102-2: After performing the addition operation of 2-period average number of use, the general information is compared in size with 2-period average numbers of use, rearranged in the ascending order of the 2-period average number of use, and the display priority order of the general information is set again.

Step S103: Customer 90 makes a telephone inquiry to call reception center 10.

Step S104: An operator of call reception center 10 receives the telephone call, and performs the reception operation of the telephone inquiry at operator terminal 40.

Step S105: Operator terminal 40 displays reception input part 101.

Step S106: Attention needed information is retrieved.

Step S107: Attention needed information display part 102 displays the attention needed information.

Step S108: The operator refers to the list of the attention needed information, and checks whether the attention needed information corresponding to the inquiry exists.

Step S109: The operator confirms the details of the attention needed information, and answers customer 90.

Step S110: The operator presses the button to transfer the confirmed attention needed information.

Step S111: The attention needed information is transferred to reception input part 101.

Step S112: Operation for inquiry acceptance and response is completed.

Step S113: Contents of the inquiry are registered in inquiry database 21.

Step S114: This period number of use of the answer example information increments by one.

Step S115: After a specific period expires, the server calculates a new 2-period average number of use and checks the applicable time and the addition rank. When the answer example information meets the time, the server adds the addition point in the additional number of use file to the 2-period average number of use to update, makes this period number of use 0, and calculates the whole average number of use and the maximum number of use.

Step S116: General information is rearranged in ascending order of the number of use.

Step S117: The display priority order is assigned to the rearranged general information with the value which is lower than that of the attention needed information at the top priority. The resultant display priority order is set in item of the answer example information.

Thus in this embodiment, the additional number of use information is managed based on the concept of rank, and is stored in another file. Therefore, it is possible to change the additional number of use easily. This lightens an administrator's workload, shortens job time, and minimizes correction errors because verification objects in contents to be corrected is minimized.

The following is the description of the seventh embodiment of this invention. As the call reception system of this embodiment has the same configuration as that of the first embodiment, FIGS. 1 and 2 are also used here.

In said fifth and sixth embodiments, the display priority order is controlled by adding the additional number of use which is managed separately when it is applicable time. However, because the number of use which is added is used successively after the additional applicable time has passed, the display priority order according to the number of use is slightly affected in adjustment of the order. As for in this embodiment, after an additional applicable time has passed, the display priority order is determined by decreasing the added number of use to return the 2-period average number of use to the original.

There are two ways to determine the display priority order; to determine the display priority order by the use point, and to determine it by a size comparison of 2-period numbers of use with. The item of addition flag is added in management information of answer example information.

When the display priority order is determined by the use point, it is determined whether it is additional applicable time, and the result of the determination determines that the column of the use point is directly transferred from 2-period average number of use or transferred from 2-period average number of use which is added by the additional number of use.

When the display priority order is determined by adding an item of the addition flag and controlling based on the size comparison of 2-period average numbers of use, the server determines whether the addition flag is on or off and whether it is applicable time or not. When the addition flag is off but it is an additional applicable time, the addition operation of 2-period average number of use is carried out after an addition flag is made on, while when the addition flag is off and it is not the time, the recording operation of the 2-period average number of use is carried out in the same way as mentioned before.

When the addition flag is on and it is not the additional applicable time, the addition flag is turned off, and the subtraction operation of the additional number of use to 2-period average number of use is carried out to return to the condition in which the original average value is recorded before the addition. When the addition flag is on and it is the time, the addition flag is maintained as it is, and the addition operation is carried out again after subtracting the additional number of use, which is added before, from 2-period average number of use. Then, the display priority order is decided by the size of the 2-period average numbers of use which is updated by the above operation.

The operation of said call reception system is described. The operation when the display priority order is determined by a use point is described. As the operation of the call reception system of this embodiment is almost the same as that of the first and the fifth embodiments, only different operations from the first and the fifth embodiments is described.

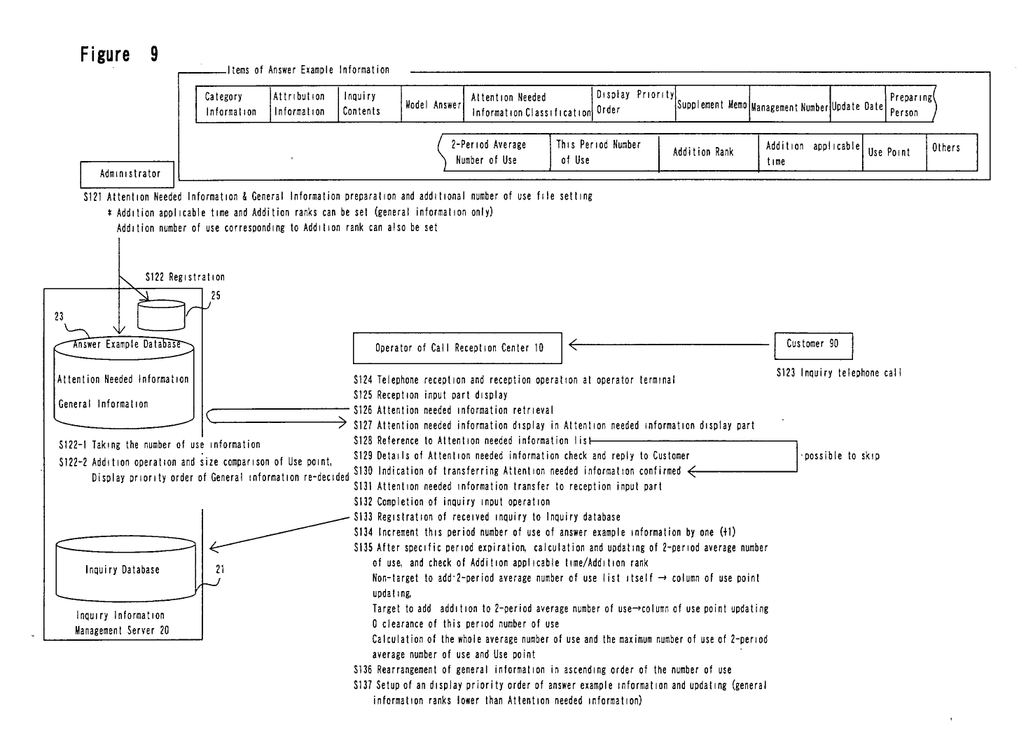

FIG. 9 shows the operation of the call reception system according to the seventh embodiment of this invention.

At first, the pre-work operation is described.

An administrator prepares the attention needed information and the general information. 2-period average number of use of the general information is input manually if necessary. Information on the addition rank (which corresponds to additional number of use file 25 managed separately) and the additional applicable time (for example, the beginning of April, or the 1st week in every month) of the additional number of use is also input manually if necessary. The items of the answer example information to be prepared are the same as that of said sixth embodiment except for the addition of the item of use point, which cannot be preset.

Prepared answer example information is previously registered (added or updated) in answer example database 23 of inquiry information management server 20 (FIG. 1) in the call reception system. When answer example information, which has been registered, is updated, the updated answer example information takes the number of use information counted in answer example database 23.

The server performs the addition operation of use points and compares the sizes of the use points. The general information is rearranged in the ascending order of the use points, and the display priority order of the general information is re-decided. Above sorting can be omitted.

The following describes the operation when the operator of the call reception center has a telephone call. Because the operation until this period number of use of the answer example information which is used in response to the telephone inquiry increments by one is the same as that of the sixth embodiment, the operation after that will be described.

Inquiry information management server 20 obtains a specific period from setting information database 24 to count the frequency of use of answer example information. When the specific period expires, the server sums up 2-period average number of use and this period number of use recorded in each answer example information which is registered in answer example database 23, and then calculates the average value of them (division by 2). Subsequently, the column of the average number of use is updated, and this period number of use is initialized to 0.

The server obtains the additional applicable time recorded on each answer example information and determines whether it is applicable time. When it is applicable time, addition rank recorded on each answer example information is recognized and the additional number of use file 25 managed as another file is referred to. Then, the additional number of use applying to the recognized additional rank is added to the average value which is calculated before. After that, the column of the use point is updated by the result. When it is not applicable time, the column of the use point is updated by 2-period number of use calculated before. The use point, the whole average number of use and the maximum number of use of 2-period average number of use are calculated in parallel. Because the following operation is the same as that of said fifth embodiment, the description about that is omitted.

The steps shown in FIG. 9 are described.

Step S121: An administrator prepares answer example information, that is, attention needed information and general information, and sets addition use number of time file 25. An additional applicable time and addition rank of general information can be set. The additional number of use corresponding to the addition rank can be also set.

Step S122: The prepared attention needed information and general information is registered in answer example data base 23 of inquiry information management server 20. At the same time additional number of use file 25 is updated.

Step S122-1: Answer example database 23 incorporates the number of use information into the answer example information.

Step S122-2: The server performs the addition operation and compares sizes of the use points, and the display priority order of the general information is re-decided.

Step S123: Customer 90 makes a telephone inquiry to call reception center 10.

Step S124: An operator of call reception center 10 receives the telephone call, and performs the reception operation of the telephone inquiry at operator terminal 40.

Step S125: Operator terminal 40 displays reception input part 101.

Step S126: The attention needed information is retrieved.

Step S127: Attention needed information display part 102 displays the attention needed information.

Step S128: The operator refers to the list of the attention needed information and checks whether the attention needed information corresponding to the inquiry exists.

Step S129: The operator confirms the details of the attention needed information, and answers customer 90.

Step S130: The operator presses the button to transfer the confirmed attention needed information.

Step S131: The attention needed information is transferred to reception input part 101.

Step S132: Operation for inquiry acceptance and response is completed.

Step S133: Contents of the inquiry are registered in inquiry database 21.

Step S134: This period number of use of the answer example information increments by one.

Step S135: After the specific period expires, a new 2-period average number of use is calculated to be updated and the applicable time and the addition rank are checked. When the answer example information is designated to be added, the addition point is added to 2-period average number of use, and the column of the use point is updated. While the information is not to be added a point, 2-period average number of use is transferred to the column of the use point. Then this period number of use is initialized to 0. The server also calculates the whole average number of use and the maximum number of use.

Step S136: General information is rearranged in ascending order of the number of use.

Step S137: The display priority order is assigned to the rearranged general information with the value which is lower than that of the attention needed information at the top priority. The resultant display priority order is set in item of the answer example information.

Thus in this embodiment, the display priority order can be controlled correctly because the display priority order is determined by the result of the calculation of which additional number of use is added only in the additional applicable time. When an operator answers customer 90, the proper attention needed information can be displayed, thereby improving the response efficiency to the inquiry and the accuracy in the attention needed information retrieval.

The following is the description of the eighth embodiment of this invention. As the configuration of the call reception system in this embodiment is the same as that of the first embodiment, FIGS. 1 and 2 are also used here.

In the second to seventh embodiments, it is necessary to calculate the average number of use which depends on the frequency of use (the number of times of pasting) of the answer example information. However, when an operator inputs an answer example information manually or performs cut-and-paste without using the pasting function after he or she refers to the information, the number of use is not counted. If such a case occurs frequently, the display priority order will become different from the actual frequency of use. There are many pieces of answer example information which are preferably preferentially displayed according to a season or time. In this embodiment, therefore, each answer example information can be set in a time (or period) to be preferably preferentially displayed and addition points to be added corresponding to the season or time.

The management information of the answer example information is allowed to hold a plurality of pairs of the item of the priority display time and the item of the addition point, or to add addition points according to the season or time of the annual schedule. The item of the display priority order decision point determines the display priority order.

Inquiry information management server 20 refers to the priority display time and the addition point of each answer example information every time the display priority order is readjusted, records the values added to those of the display priority order in the display order decision point, and determines the display priority order by a size comparison of the display order decision points. This way doesn't depend on the number of use, and can display the answer example information which is suitable for the display time. The system used in this embodiment may be used in association with the system used in the second to fourth embodiments.

The operation of said configured call reception system is described. The operation which determines display priority order by addition points in a specific season based on the annual schedule will be described. As the operation of the call reception system of this embodiment is almost the same as those of the first and the fourth embodiments, only different operations from the first and the fourth embodiments is described.

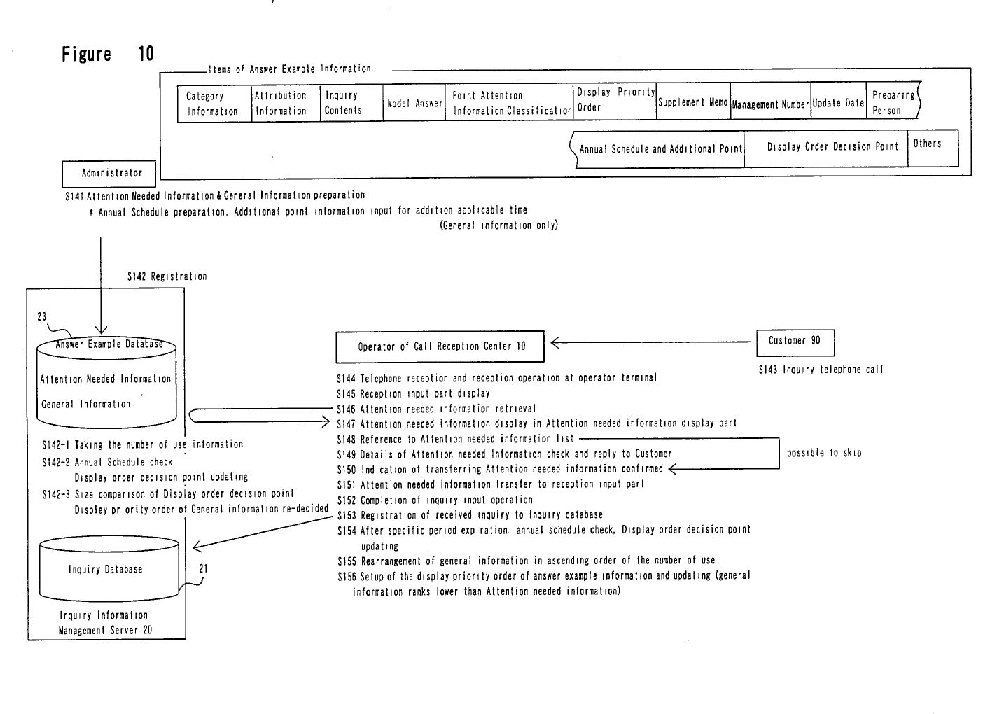

FIG. 10 shows the operation of the call reception system according to the eighth embodiment of this invention.

At first, the pre-work operation is described.

An administrator prepares attention needed information and general information. As for the general information, the administrator inputs addition point information corresponding to the time to be preferably displayed in a column of the item of the annual schedule in each answer example information. It is allowed that the above addition point can be input to more than one column with different points.

The items of answer example information to be prepared are items which remove the items of 2-period average number of use and this period number of use from the items of the fourth embodiment but adds the item of annual schedule and addition point. It is allowed to hold a plurality of pair of the items of the priority display time and additional points. The item of the display order decision point to determine the display priority order is also added. It is allowed that the item of the addition point is used as a rank as in the sixth embodiment and corresponds to the addition point information in another file.

Prepared answer example information is previously registered (added or updated) in answer example database 23 of inquiry information management server 20 (FIG. 1) in the call reception system. As for the answer example information which has already registered, the items of the annual schedule and the addition points of each answer example information are referred, and it is determined whether addition points are necessary for this time. When the addition points are applied to the time, the addition points are transferred to the column of the display order decision point in the value of the display priority order.

With a size comparison of display order decision points, general information is rearranged in the ascending order, and the display priority order is re-decided. Above rearrangement can be omitted.

The following describes the operation when the operator of the call reception center has a telephone call. Because the operation until the contents of a received inquiry are registered in database 21 is the same as that of the first embodiment so that the operation after that will be described.

Inquiry information management server 20 obtains a specific period from setting information database 24 to count the frequency of use of answer example information. When the specific period expires, the server once initializes the display priority order decision point into 0 and obtains the additional applicable time from the annual schedule recorded on each answer example information in answer example database 23, and determines whether it is the additional applicable time (the addition time). When it is the additional applicable time, the addition points are transferred to the column of the display order decision point.

The server extracts only general information, compares each display order decision point of the information in size, and arranges the information in ascending order of the display order decision point. Each answer example information can hold the display order information and rewrite the information.

Then, the display priority order is assigned a lower value than that of the attention needed information according to the rearranged order, and the item of the display priority order of the answer example information is rewritten and updated by the result. The attention needed information set at the time when an administrator has prepared answer example information is not updated in the display priority order at attention needed information display part 102 (FIG. 2).

The steps shown in FIG. 10 are described.

Step S141: An administrator prepares attention needed information and general information. The administrator also prepares annual schedule and inputs addition information applied to the addition time for the general information.

Step S142: Prepared attention needed information and general information is registered in answer example data base 23 of inquiry information management server 20.

Step S142-1: Answer example database 23 incorporates the number of use information into the answer example information.

Step S142-2: The annual schedule is checked and the display order decision point is updated.

Step S142-3: With a size comparison of display order decision points, the general information is rearranged in the ascending order, and the display priority order of the general information is re-decided.

Step S143: Customer 90 makes a telephone inquiry to call reception center 10.

Step S144: The operator of call reception center 10 receives a telephone call, and performs the reception operation of the telephone inquiry at operator terminal 40.

Step S145: Operator terminal 40 displays reception input part 101.

Step S146: The attention needed information is retrieved.

Step S147: Attention needed information display part 102 displays the attention needed information.

Step S148: The operator refers to the list of the attention needed information and checks whether the attention needed information corresponding to the inquiry exists.

Step S149: The operator confirms the details of the attention needed information and answers customer 90.

Step S150: The operator presses the pasting button to transfer the confirmed attention needed information.

Step S151: The attention needed information is transferred to reception input part 101.

Step S152: Operation for inquiry acceptance and response and response is completed.

Step S153: Contents of the accepted inquiries are registered in inquiry database 21.

Step S154: After the specific period expires, the annual schedule is checked and the display order decision point is updated.

Step S155: The general information is rearranged in ascending order by the display order decision point.

Step S156: The display priority order is assigned to the rearranged general information with the value which is lower than that of the attention needed information at the top priority. The resultant display priority order is set in item of the answer example information.

In this embodiment, it is possible to hold a plurality of pairs of the items of the priority display time and the addition points, and to determine the display priority order by adding points at the specific time based on the annual schedule which is previously prepared by considering factors such as times or seasons. Therefore, it is possible to display the answer example information with the priority in accordance with the intention of the administrator who has prepared the answer example information even if the count for the number of use is not correct. In this embodiment, it is allowed to increase the point which is given to each answer example information as the fixed display order decision point or decrease the point which is previously added.

The following is the description of the ninth embodiment of this invention. As the configuration of the call reception system in this embodiment is the same as that of the first embodiment, FIGS. 1 and 2 are also used here.

In said first to eighth embodiments, attention needed information stays as attention needed information unless the administrator manually changes the setting for that. It is considered that the answer example information corresponding to the announcement of new products or changes of law, institution and system is used frequently just before or after the announcement or changes because of much inquiries about that. But it is assumed that those inquiries decrease soon after a specific time passes. In the first to eighth embodiments, it is necessary to watch the time and delete the attention needed information from the setting, thereby causing a troublesome work, i.e., someone has to check the conditions such as inquiry frequency and to change the setting of the attention needed information. In this embodiment, the attention needed information is set for a fixed time and managed with the priority order depending on a size such as 2-period average number of use after expiration of the time so that the information is set as the attention needed information is deleted from the setting after a fixed season or time has passed. In other words, it is able to perform the deletion control of the attention needed information.

New answer example information can be displayed as announcement and each operator can confirm contents of the information anytime. The priority order can be automatically changed according to the number of use after the fixed time has elapsed (after the validity of the attention needed information).

The operation of said call reception system is described. As the operation of the call reception system of this embodiment is almost the same as those of the first and the fourth embodiments, only different operations from the first and the fourth embodiments is described.

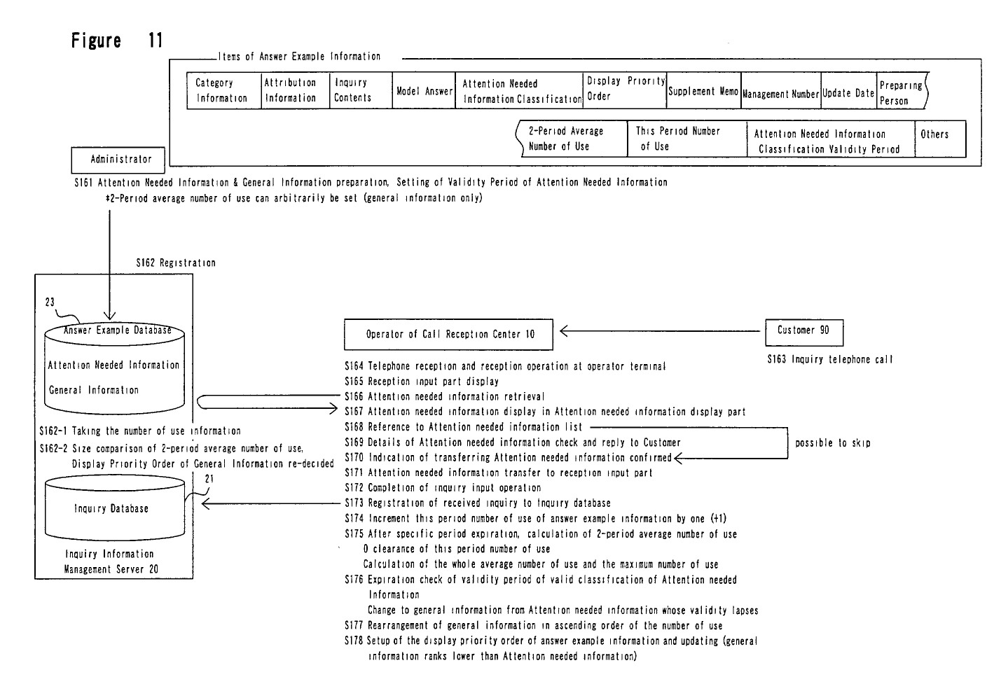

FIG. 11 shows the operation of the call reception system according to the ninth embodiment of this invention.

At first, the pre-work operation is described.

An administrator prepares attention needed information and general information. 2-period average number of use of the general information is input manually if necessary.

The items of said answer example information include the classification information which becomes the key to narrow answer example information, the attribute information which the attribute (category) of the answer example information is shown in, contents of an inquiry and a model answer, the attention needed information classification to show the attention rank or frequency of use of the answer example information, the display priority order to attention needed information display part 102 of input screen 100 (FIG. 2), the supplement memorandum, the control number, the updating date, the preparation person, 2-period average number of use, and this period number of use with the item of the attention needed information classification validity (or time limit).

Prepared answer example information is previously registered (added or updated) in answer example database 23 of inquiry information management server 20. When answer example information, which has been registered, is updated, the newly registered (updated) answer example information takes the number of use information counted in answer example database 23.

With a size comparison of 2-period average numbers of use, the general information is rearranged in the ascending order (rearrangement can be omitted.), and the display priority order of general information is re-decided.

The following describes the operation when an operator of the call reception center has a telephone call. Because the operation until this period number of use of the answer example information which is used in response to the telephone inquiry increments by 1 is the same as that of the sixth embodiment, the operation after that will be described.

Inquiry information management server 20 obtains a specific period from setting information database 24 to count the frequency of use of the answer example information. When the specific period expires, the server sums up 2-period average number of use and this period number of use recorded on each answer example information which is registered in answer example database 23, and then calculates the average value (division by 2) of them. Then, the column of the 2-period average number of use is updated by the calculated average value, and this period number of use is initialized to 0. The server also calculates the whole average number of use and the maximum number of use in parallel.

The server checks a valid period of the attention needed information classification of attention needed information. The attention needed information, whose validity is not effected, is removed from the attention needed information setting and re-set as general information. Then only general information is extracted and rearranged in the ascending order by the size comparison of 2-period average numbers of use which is updated. Though a rearrangement method is described here, it is allowed only to update the display priority information without rearranging the general information.

The result of the assignment of the display priority order with a lower value than that of the attention needed information to the rearranged order updates the item of the display priority order of the answer example information. As for the attention needed information set at the time when an administrator has prepared the answer example information, the display priority order in attention needed information display part 102 is not updated. When attention needed information validity time has not been set at the time of preparation, the period set up in advance can be automatically incorporated into the attention needed information validity time.

The steps shown in FIG. 11 are described.

Step S161: An administrator prepares attention needed information and general information, and sets the attention needed information classification validity time of the attention needed information. 2-period average number of use of the general information can be set optionally.

Step S162: The prepared attention needed information and general information is registered in answer example database 23 of inquiry information management server 20.

Step S162-1: Answer example database 23 incorporates the number of use information into the answer example information.

Step S162-2: With a size comparison of 2-period average numbers of use, the general information is rearranged in the ascending order, and the display priority order of general information is re-decided.

Step S163: Customer 90 makes a telephone inquiry to call reception center 10.

Step S164: An operator of call reception center 10 receives the telephone call, and performs the reception operation of the telephone inquiry at operator terminal 40.

Step S165: Operator terminal 40 displays reception input part 101.

Step S166: Attention needed information is retrieved.

Step S167: Attention needed information display part 102 displays the attention needed information.

Step S168: The operator refers to the list of the attention needed information and checks whether the attention needed information corresponding to the inquiry exists.

Step S169: The operator confirms the details of the attention needed information and answers customer 90.

Step S170: The operator presses the button to transfer the confirmed attention needed information.

Step S171: The attention needed information is transferred to reception input part 101.

Step S172: Operation for inquiry acceptance and response is completed.

Step S173: Contents of accepted inquiries are registered in inquiry database 21.

Step S174: This period number of use of the answer example information increments by one.

Step S175: After a specific period expires, 2-period average number of use is calculated and this period number of use is made 0. The server also calculates both the whole average number of use and the maximum number of use.

Step S176: The server checks the validity of the attention needed information, removes from the setting the attention needed information whose validity is not effect, and sets the removed information as general information.

Step S177: The general information is rearranged in the ascending order of the number of use.

Step S178: The display priority order is assigned to the rearranged general information with the value which is lower than that of the attention needed information at the top priority. The resultant display priority order is set in item of the answer example information.

In this embodiment, the attention needed information is set only for a fixed time and managed by the priority order depending on the size of such a 2-period average number of use after the expiration of the fixed time. In other words, it is able to perform the invalidation management of the attention needed information. Therefore, the answer example information corresponding to the announcement of new products or the change of law, institution and system can be displayed as attention needed information at priority at the time of just after the announcement or change. In this time period it is expected that there are many inquiries about the announcement or change and the information is needed most frequently. When the above mentioned period passes and inquiries decrease steeply, the attention needed information about the announcement or change is vacated automatically. Operator terminal 40 can automatically avoid displaying the out-of-time attention needed information.

In the first to eighth embodiments, the checking of attention needed information i.e., checking of the frequency of inquiries and the removal of the expired attention needed information, should be performed manually. In this embodiment, however, the checking of the attention needed information is performed automatically.

Furthermore, new answer example information can be announced to operators and confirmed by each operator anytime. The display order can be automatically switched by the number of use after the fixed time has passed.

The following is the description of the tenth embodiment of this invention. As the configuration of the call reception system in this embodiment is the same as that of the first embodiment, FIGS. 1 and 2 are also used here.

In the ninth embodiment, the attention needed information classification validity time is set up manually, and the setting as attention needed information is automatically removed from the attention needed information classification upon elapse of the validation time. It is, however, difficult to determine the attention needed information classification validity time. In this embodiment, therefore, attention needed information having a number of use less than a threshold value after a comparison of the 2-period average numbers of use with this period number of use or less than the number of use calculated from the threshold by ratio, or having a period number of use less than a threshold is automatically removed from the attention needed information classification and moved to general information.

By providing the system which informs to an administrator that attention needed information is automatically removed, the administrator can grasp the condition of the attention needed information and make the information useful at the next updating. Though the configuration of the system of this embodiment is the same as that of the eighth embodiment, the system of this embodiment has a function to manage the threshold value and determine whether the number of use is under the threshold value, and a function to change the attention needed information to general information when the number of use is under the threshold value and report the removal of attention needed information to the administrator by an electronic mail. Attention needed information classification validity period as a managed item of answer example information is unnecessary in this embodiment.

When the attention needed information is updated, the system is allowed to choose setting of the items of attention needed information classification with managed items of the answer example information which has been registered or which shall be updated.

The operation of said call reception system is described. As the operation of the call reception system of this embodiment is almost the same as that of the first and the ninth embodiments, only different operations from the first and the ninth embodiments is described.

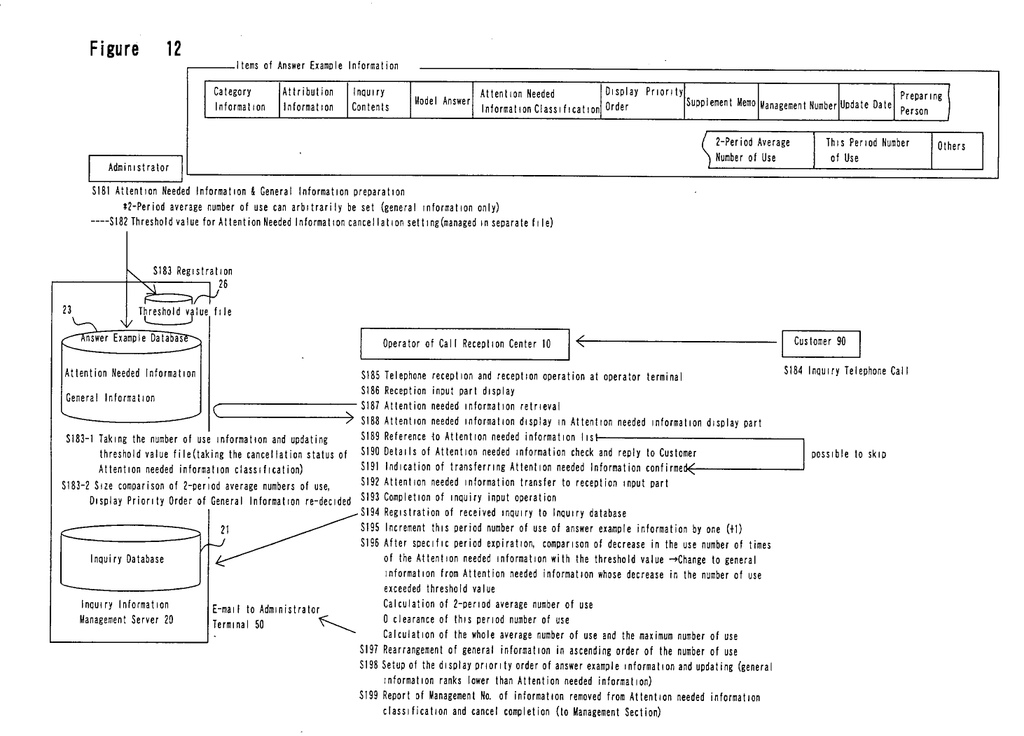

FIG. 12 shows the operation of the call reception system according to the tenth embodiment of this invention.

At first, the pre-work operation is described.

An administrator prepares attention needed information and general information. 2-period average number of use of the general information is input manually if necessary.

The items of said answer example information which is prepared include the classification information (the key to narrow the range of the information), the attribute information (for example category group and category classification), contents of an inquiry and a model answer, the attention needed information classification to show the rank of importance and the frequency of use, the display priority order to attention needed information display part 102 of input screen 100 (FIG. 2), the supplement memo, the management number, updating date, preparation person, 2-period average number of use, and this period number of use. The item of the attention needed information validity (or time limit) of the ninth embodiment is not used in the tenth embodiment. Then threshold value information, which corresponds to the number of use as the value to decide whether the attention needed information classification is cancelled, is input to threshold value file 26 which is stored as another file.

Prepared answer example information is previously registered (added or updated) in answer example database 23 of inquiry information management server 20. When answer example information, which has been registered, is updated, it takes the number of use information counted in answer example database 23. The system takes over the setting cancellation applied to the attention needed information classification if necessary. The updating of threshold value file 26 is also performed.

After comparing 2-period average numbers of use in size with one another, the general information is sorted in the ascending order, and the display priority order of the general information is re-decided. Sorting can be omitted.

The following describes the operation when receiving the telephone inquiry. Because the operation until this period number of use of answer example information which is used in response to the telephone inquiry increments by one is the same as that of the ninth embodiment, the operation after that will be described.

Inquiry information management server 20 obtains a specific period from setting information data base 24 to count use frequency of the answer example information. Then when the period expires, a comparison of the 2-period average numbers of use with this period number of use in recorded on each answer example information in answer example data base 23 is performed, and it is determined whether the attention needed information classification should be canceled on the basis of the threshold information stored in threshold value file 26. The setting for the attention needed information is cancelled, if necessary.

The sum of 2-period average number of use and this period number of use, which are recorded in each answer example information of answer example data base 23, is calculated in each answer example information. Then, the column of 2-period average number of use is rewritten and updated by the result of the calculation of the average (divided by 2), and this period number of use is made 0. Furthermore, the whole average number of use and the maximum number of use are calculated together in parallel.

As for the operation after that, the description is omitted because it is the same as that of the ninth embodiment.

At last the administrator is informed of completion of the cancellation of the attention needed information classification with the management number by an electronic mail to administrator terminal 50.

The steps shown in FIG. 12 are described.

Step S181: An administrator prepares attention needed information and general information, and sets up threshold value file 26. The 2-period average number of use of the general information can be set up optionally.

Step S182: Threshold values for cancellation of the attention needed information classification is set in threshold value file 26 which is stored in another file.

Step S183: The prepared attention needed information and general information is registered in answer example data base 23 of inquiry information management server 20. At the same time threshold value file 26 is updated.

Step S183-1: Answer example database 23 incorporates the number of use information into the answer example information, and updates threshold value file 26. Answer example database 23 also takes the cancellation of the attention needed information classification, if necessary.

Step S183-2: As for the general information, 2-period average numbers of use are compared to one another, and arranged in the ascending order. Then the display priority order of the general information is re-decided.

Step S184: Customer 90 makes a telephone inquiry to call reception center 10.

Step S185: An operator of call reception center 10 receives the telephone call, and performs the reception operation of the telephone inquiry at operator terminal 40.

Step S186: Operator terminal 40 displays reception input part 101.

Step S187: The attention needed information is retrieved.

Step S188: Attention needed information display part 102 displays attention needed information.

Step S189: Referring to the list of the attention needed information, the operator checks whether attention needed information corresponding to the inquiry exists.

Step S190: The operator confirms the detailed information of the attention needed information, and answers customer 90.

Step S191: The operator transfers the confirmed attention needed information.

Step S192: The attention needed information is transferred to the reception input part 101.

Step S193: Operation for inquiry acceptance and response is completed.

Step S194: The contents of the accepted inquiry are registered in inquiry data base 21.

Step S195: This period number of use of answer example information increments by one.

Step S196: After a specific period expires, the threshold value is compared with the decreased number of use of the attention needed information, and the answer example information which has exceeded the threshold value is canceled from the attention needed information classification, and set up again as a general information. Then, 2-period average number of use is calculated and this period number of use is made 0. The server also calculates both the whole average number of use and the maximum number of use.

Step S197: The general information is rearranged in ascending order of the number of use.

Step S198: The display priority order is assigned to the rearranged general information with the value which is lower than that of the attention needed information at the top priority. The resultant display priority order is set in item of the answer example information.

Step S199: At last the administrator is informed of the answer example information to be completed the cancellation of the attention needed information classification with the management number by an electronic mail to administrator terminal 50.

In this embodiment, the cancellation of the attention needed information classification is performed based on the number of use. That improves the reliability of the cancellation operation of the attention needed information classification. It is not necessary for an administrator to think about setting values such as use period of the attention needed information and to set it up any more, and the efficiency of the updating work of the answer example information and the additional work of new answer example information is improved.

Because an administrator can grasp the updating status of the cancellation of the attention needed information classification by the informing function to administrator terminal 50, he or she can reflect the conditions on the answer example information updating work later.

This invention is not limited to the above described and illustrated embodiments, and various change and modifications may be made without departing from the spirit and scope of this invention.

What is claimed is:

1. A call reception system comprising:
(a) a server equipped with a database to register inquiry examples and answer examples to said inquiry examples made in advance; and,
(b) an operator terminal equipped with a display device to display said inquiry examples and answer examples, and
(c) wherein said display device displays attention needed information.

2. The call reception system according to claim 1, wherein said display device always displays said attention needed information.

3. The call reception system according to claim 1, wherein said display device displays said attention needed information by an operator's operation.

4. The call reception system according to claim 1, wherein said attention needed information is an inquiry example and an answer example to said inquiry example to which an operator should pay attention.

5. The call reception system according to claim 1, wherein said display device gives attention level classification information to said attention needed information to display.

6. The call reception system according to claim 1, wherein said display device may display the screen to input the content of a received inquiry with said attention needed information.

7. The call reception system according to claim 1, wherein said display device displays the screen to display the details of said attention needed information.

8. A call reception system comprising:
(a) a server equipped with a database to register inquiry examples and answer examples to said inquiry examples made in advance; and,
(b) an operator terminal equipped with a display device to display said inquiry examples and answer examples, and
(c) wherein said database registers attention level classification information corresponding to said inquiry examples and answer examples.

9. The call reception system according to claim 8, wherein said attention level classification information is information to distribute whether information is attention needed information.

10. The call reception system according to claim 8, wherein said attention level classification information is set when said inquiry examples and answer examples are registered.

11. The call reception system according to claim 8, wherein said attention level classification information is set in accordance with a specific season or time.

12. The call reception system according to claim 11, wherein said attention level classification information is canceled in setting when said season or time has passed.

13. The call reception system according to claim 8, wherein said database registers the priority order to display said inquiry examples and answer examples in said display device.

14. The call reception system according to claim 13, wherein said priority order is set based on the use actual results of said inquiry example and the answer example.

15. The call reception system according to claim 13, wherein said priority order is set in accordance with a specific season or time.

16. The call reception system according to claim 15, wherein said priority order is cancelled in setting when said season or time has passed.
